(19) United States
(12) Patent Application Publication
(10) Pub. No.: US 2006/0092592 A1
(43) Pub. Date: May 4, 2006

(54) ESD protection circuit with adjusted trigger voltage

(75) Inventor: Shao-Chang Huang, Hsinchu City (TW)

Correspondence Address: DUANE MORRIS LLP;IP DEPARTMENT (TSMC), 30 SOUTH 17TH STREET, PHILADELPHIA, PA, 19103-4196, US

(73) Assignee: Taiwan Semiconductor Manufacturing Co.

(21) Appl. No.: 10/965,365

(22) Filed: Oct. 14, 2004

(51) Int. Cl. H05F 3/02

(52) U.S. Cl. 361/220

(57) ABSTRACT

An ESD protection circuit includes a NMOS transistor connected between a first pad and a second pad coupled to ground. A voltage differentiation module is connected between a gate of the NMOS transistor and the second pad for creating a bias on the gate during the ESD event, thereby activating a surface current path in addition to a substrate current path for dissipating the ESD current. The voltage differentiation module is formed by a segment of a guard ring, which provides a predefined resistance determining the bias on the gate.

### BACKGROUND

The present disclosure relates generally to semiconductor circuit designs, and more particularly to an electrostatic discharge (ESD) protection circuit with an adjustable trigger voltage.

Integrated circuits (ICs) are susceptible to a variety of reliability problems. One of the reliability issues is the possible vulnerability to ESD events. An ESD event occurs when a charged object, such as a human body with a static buildup or a piece of equipment that has a potential different from that of an IC, discharges into the IC. The discharge consists, typically, of current levels exceeding one ampere within 200 nanoseconds. The magnitude of the peak current and the wave shape of the discharge depend on the effective charge resistance, capacitance, and inductance of the objects experiencing the ESD event. The result of ESD on unprotected ICs is often destruction, characterized by melting or explosion of a part of the IC. It is a common practice for an IC designer to include extra components in an IC to provide ESD paths that bypass the components used for normal circuit functions. These normal circuit components are, therefore, protected from the ESD event.

Various attempts have been made to provide a circuit associated with IC interface pads to prevent a core circuit of the IC from an ESD damage. One known technique for providing a degree of protection is to connect a grounded gate NMOS (GGNMOS) transistor between the interface pads and the core circuit. During a normal IC operation, the GGNMOS transistor is “off” and has no effect on the core circuitry. However, when an ESD event occurs, the ESD current will cause the GGNMOS transistor to breakdown, and create a substrate current path, through which the ESD current is diverted to ground. Therefore, the core circuit is protected from the ESD event. The GGNMOS transistor resets itself to an “off” condition upon return to the normal operation mode.

The GGNMOS transistor has certain performance limitations. The NMOS transistor trigger voltage is typically fixed and relatively high. Complicated changes of layouts and masks are needed to adjust the trigger voltage of the GGNMOS transistor. As future IC designs move towards lower supply voltages (below 3.3V), there is an increasing need for an ESD protection circuit with a lower trigger voltage.

Therefore, desirable in the art of ESD protection designs are improved ESD protection circuits with adjustable trigger voltages that provide enhanced ESD protection, without a complicated rearrangement of circuit layouts.

### SUMMARY

The invention discloses an electrostatic discharge (ESD) protection circuit connected between a first pad and a second pad coupled to ground for diverting an ESD current during an ESD event. In one embodiment, the ESD protection circuit includes a NMOS transistor connected between the first pad and the second pad. A voltage differentiation module is connected between a gate of the NMOS transistor and the second pad for creating a bias on the gate during the ESD event, thereby activating a surface current path in addition to a substrate current path for dissipating the ESD current. The voltage differentiation module is formed by a segment of a guard ring, which provides a predefined resistance determining the bias on the gate.

The construction of the invention, however, together with additional objects and advantages thereof will be best understood from the following description of specific embodiments when read in connection with the accompanying drawings.

### BRIEF DESCRIPTION OF THE DRAWINGS

FIGS. 1A and 1B illustrate a conventional ESD protection circuit utilizing a GGNMOS transistor, and its cross-sectional view.

FIG. 2 presents a voltage-current graph showing the avalanche breakdowns of the GGNMOS transistor in the conventional ESD protection circuit.

FIGS. 3A and 3B illustrate an ESD protection circuit with an adjustable trigger voltage, and its cross-sectional view, in accordance with one embodiment of the present invention.

FIGS. 4A and 4B illustrate an ESD protection circuit with an adjustable trigger voltage, and its cross-sectional view, in accordance with another embodiment of the present invention.

FIG. 5 illustrates an ESD protection circuit with an adjustable trigger voltage, in accordance with another embodiment of the present invention.

FIG. 6 illustrates an ESD protection circuit with an adjustable trigger voltage and a tie-low circuit, in accordance with another embodiment of the present invention.

FIG. 7A illustrates a layout of the conventional ESD protection circuit.

FIGS. 7B and 7C illustrate layouts of the ESD protection circuit, in accordance with various embodiments of the present invention.

FIGS. 8A and 8B illustrate graphs showing experimental results of the disclosed ESD protection circuit, compared to conventional ESD protection circuits, in accordance with one embodiment of the present invention.

### DESCRIPTION

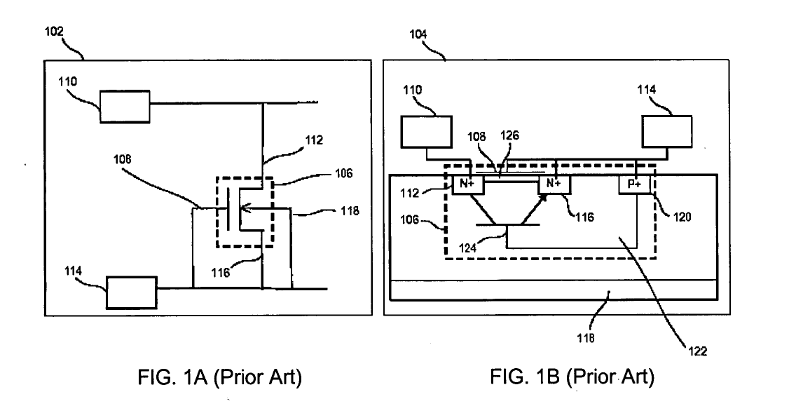

FIGS. 1A and 1B illustrate a conventional ESD protection circuit 102, and its a cross-sectional view 104. The conventional ESD protection circuit 102 provides a degree of protection to an IC by utilizing a NMOS transistor 106, having its gate 108 grounded, to provide a path for the discharge of an ESD current. A pad 110, such as an input/output pad of the IC, is tied to a drain 112 of the NMOS transistor 106. In this configuration, the grounded gate 108 is tied to a pad 114, which is further connected to ground. In addition, a source 116 and a bulk 118 of the NMOS transistor 106 is connected to the pad 114. The bulk 118 is the connection to the substrate of the NMOS transistor 106. It is understood that this grounded gate NMOS transistor 106 is in parallel with a core circuit (not shown) that is to be protected from ESD events.

The parasitic lateral NPN transistor or its equivalent is formed in the bulk 118 with an overlying P well 122, which is usually a few micrometers thick. A N+ diffusion region serves as a collector, which is essentially the drain 112 of the NMOS transistor 106. Another N+ diffusion region functions as an emitter, which is essentially the source 116 of the NMOS transistor 106. A base 124 is connected to a P+ substrate connection 120 through the P well 122. A channel region 126 is the area between the collector and emitter that conducts the drain-source current.

In a normal operation, the pad 110 receives signals that vary between VCC and VSS. It is understood by those skilled in the art that VCC refers to the operation voltage of the IC, and VSS typically refers to ground voltage. The NMOS transistor 106 will remain “off,” due to the grounded gate 108. Thus, the ESD protection circuit 102 has no effect on the core circuit that is to be protected.

When an ESD event occurs, thereby generating an ESD voltage that is significantly higher than the VCC voltage on the pad 110, the drain-to-source voltage of the NMOS transistor 106 will increase rapidly. The large drain voltage of the NMOS transistor 106 increases the bias voltage on the PN junction between the drain 112 and the bulk 118. This bias voltage will reach a point where the bias junction undergoes an avalanche breakdown, which results in a current flow. The additional electron-hole pairs created by the breakdown causes the potential of the P well 122 to rise until the PN junction between the channel region 126 and the emitter 116 becomes forward biased. This causes the parasitic lateral NPN transistor to conduct, with the drain 112 functioning as the collector, the channel region 126 acting as the base, and the source 116 acting as the emitter. This creates a substrate current path, through which the ESD current can dissipate to ground through the pad 114.

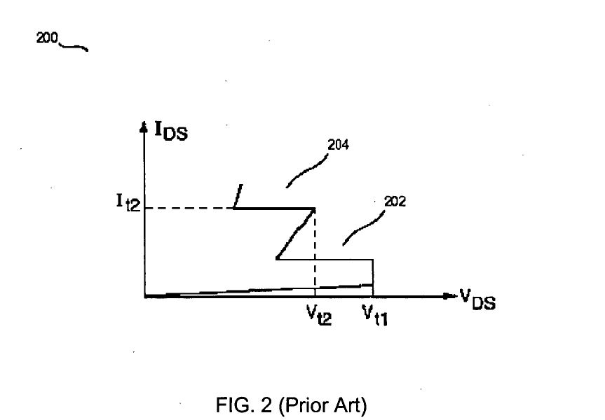

FIG. 2 presents a voltage-current graph 200 showing the avalanche breakdowns of the NMOS transistor 106, as shown in FIG. 1A. The voltage V_{DS} refers to the drain-to-source voltage, and the current IDS refers to the drain-source current. The first avalanche breakdown occurs at Vₜ₁. The conductive action of the parasitic lateral NPN transistor equivalent causes the voltage V_{DS} to drop as indicated by the graph line 202. This action is also called “snapback.” It is this action that provides the ESD protection for the IC by clamping the ESD voltage to a safe level. If the current is permitted to increase further, a second breakdown will occur at Vₜ₂, as represented by a graph line 204. In this scenario, the drain-source current will increase to Iₜ₂.

It is always desirable to turn on the NMOS transistor that is used in the ESD protection circuit as early as possible during an ESD event, such that the core circuit can be better protected from the ESD current. In order to turn on the NMOS transistor earlier, many research efforts have been dedicated to lowering its trigger voltage. One idea is to apply a certain bias to the gate of the NMOS transistor during the ESD event. The bias will help to create a surface current path under the gate, in addition to the substrate current path, for dissipating the ESD current. In such case, the ESD current can pass through both the surface and substrate current paths. This would lower the trigger voltage of the ESD protection circuit. While many efforts have been made to realize such idea, no completely satisfying result has been achieved. Some proposed solutions have not been verified as feasible. Others make the circuit layout design too complicated to implement.

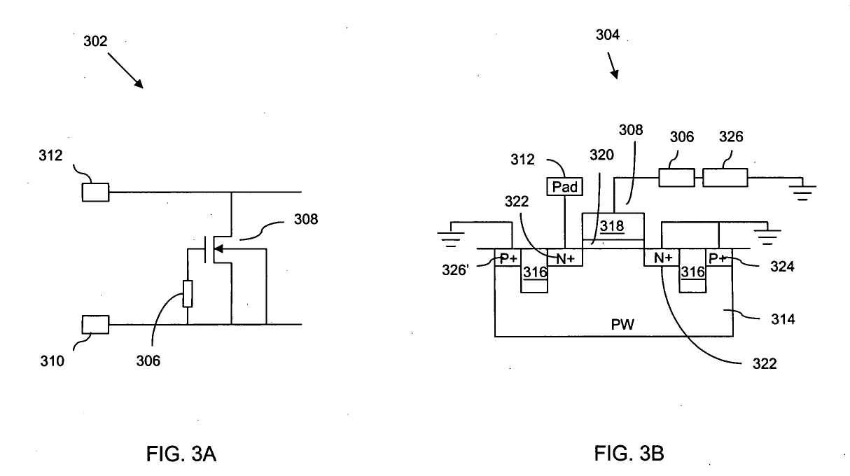

FIGS. 3A and 3B present an ESD protection circuit 302, and a cross-sectional view 304 of the same, in accordance with one embodiment of the present invention. In this embodiment, a NMOS transistor with an adjustable trigger voltage is disclosed. A voltage differentiation module, such as a resistor, is connected between the gate of the NMOS transistor and ground. This resistor comes from a segment of a guard ring, and may be adjustable by varying the length thereof. This varies the resistance, and a bias applied to the gate of the NMOS transistor. By extension, the trigger voltage of the ESD protection circuit is adjusted. No additional components, masks, or layout areas are needed to add this enhanced functionality. This embodiment provides a novel utilization of the guard ring. The adjustable trigger voltage capability enhances the performance of the ESD protection circuit.

The ESD protection circuit 302 includes a NMOS transistor 308 connected between a first pad 312, which is connected to input/output signals, and a second pad 310, which is connected to ground. The bulk of the NMOS transistor 308 is connected to ground through the second pad 310. A voltage differentiation module 306, such as a resistor, is coupled between the gate of the NMOS transistor 308 and the second pad 310. In this embodiment, the voltage differentiation module 306 utilizes a segment of a guard ring to create a resistance between the gate of the NMOS transistor 308 and the second pad 310.

In a normal operation, the NMOS transistor 308 is always turned off because its gate is connected to ground through the second pad 310. The voltage signals input through the first pad 312 will travel directly to the core circuit, without being diverted to the grounded second pad 310 through the NMOS transistor 308. In other words, the NMOS transistor 308 is invisible to the core circuit in the normal operation.

During an ESD event, the first pad 312 receives an ESD current, which immediately increase the voltage level at the drain of the NMOS transistor 308. Eventually, this causes an avalanche breakdown, the NMOS transistor 308 conducts through a substrate current path. A great amount of ESD current will be, therefore, diverted to the guard ring, which is in connection with the second pad 310, through the NMOS transistor 308. Due to the resistance provided by the voltage differentiation module 306, a part of the current passing through it will generate a bias applied to the gate of the NMOS transistor 308. This helps to turn on the NMOS transistor 308, and creates a surface current path under its gate, in addition to the substrate current path, for passing the ESD current. As a result, the trigger voltage of the NMOS transistor 308 is lowered. This allows the NMOS transistor 308 to respond to the ESD current more quickly. Thus, the performance of the ESD protection circuit 302, as a whole, is improved.

FIG. 3B illustrates a cross-sectional view 304 of the ESD protection circuit 302 shown in FIG. 3A. A P-type well 314 is formed on a semiconductor substrate. One or more isolation structures 316 are disposed on the P well 314 to define an active area, on which the NMOS transistor 308 is formed. The NMOS transistor 308 has a gate composed of a gate conductor 318 on top of a gate dielectric layer 320. Two N-type diffusion regions 322 are formed adjacent to the gate dielectric layer 320 on the P well 314, serving as the source and drain. A P-type diffusion region 324 is formed by the isolation structure 316 on the P well 314, serving as a substrate contact. The drain of the NMOS transistor 308 is connected to the first pad 312, and its source is connected to the diffusion region 324 and further connected to ground, or the second pad 310 shown in FIG. 3A. A part of the grounded guard ring 326 is depicted as a P-type diffusion region 326′ on the P well 314. The guard ring 326 surrounds a lager area, in which the NMOS transistor 308 is disposed as one of the devices. Typically, the guard ring 326 is constituted of a stack of a polysilicon layer and a silicide layer, which are aligned with one or more metal layers and in contact with the same through interconnections. A part of the metal layers is removed to expose a segment of the silicide layer of guard ring 326, to form the voltage differentiation module 306 that is further connected to the gate conductor 318. The resistance of the voltage differentiation module 306 depends on characteristics of the exposed segment. When an ESD current flows through the voltage differentiation module 306, due to its resistance, it generates a bias thereacross. This bias helps to turn on the NMOS transistor 308, and creates a surface current path under the gate dielectric layer 320, in addition to the substrate current path that is created by the avalanche breakdown across the source/drain diffusion regions 322. Because of these two current paths, the trigger voltage of the ESD protection circuit 304 can be lowered.

Since the length of the exposed silicide/polysilicon composite determines the resistance value of the voltage differentiation module 306, the bias applied to the gate conductor 318 is adjustable by controlling the length of the silicide/polysilicon composite. Because the voltage differentiation module 306 comes from the guard ring, it occupies no additional layout area, and no complicated design is required to achieve this ESD protection circuit 304 with this improved performance.

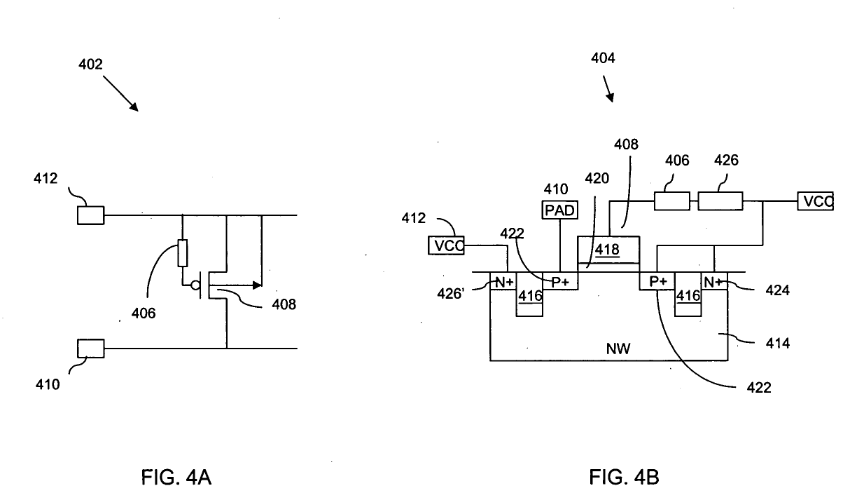

FIG. 4A illustrates an ESD protection circuit 402, in accordance with another embodiment of the present invention. The ESD protection circuit 402 includes a PMOS transistor 408 connected between a first pad 412, which is connected to input/output signals, and a second pad 410, which is connected to ground. The first pad 412 further connects the input/output signals to a core circuit. The bulk of the PMOS transistor 408 is connected to the input/output signals through the first pad 412. A voltage differentiation module 406, such as a resistor, is coupled between the gate of the PMOS transistor 408 and the first pad 412. In this embodiment, the voltage differentiation module 406 utilizes a segment of a guard ring to create a resistance between the gate of the PMOS transistor 408 and the first pad 412.

In a normal operation, the PMOS transistor 408 is always turned off, when a high voltage is input from the first pad 412. The input signals will travel directly to the core circuit, without being diverted to the grounded second pad 410 through the PMOS transistor 408. In other words, the PMOS transistor 408 is invisible to the core circuit in the normal operation.

During an ESD event, a great amount of ESD current will be diverted to the guard ring, which is in connection with the first pad 412. Due to the resistance provided by the voltage differentiation module 406, a part of the current passing through it will generate a bias between the gate of the PMOS transistor 408 and its bulk. This helps to turn on the PMOS transistor 408, and creates a surface current path, in addition to a substrate current path, under its gate for passing the ESD current. As a result, the trigger voltage of the PMOS transistor 408 is lowered. This allows the PMOS transistor 406 to respond to the ESD current more quickly. Thus, the performance of the ESD protection circuit 402, as a whole, is improved.

FIG. 4B illustrates a cross-sectional view 404 of the ESD protection circuit 402 shown in FIG. 4A. A N-type well 414 is formed on a semiconductor substrate. One or more isolation structures 416 are disposed on the N well 414 to define an active area, on which the PMOS transistor 408 is formed. The PMOS transistor 408 has a gate, which is composed of a gate conductor 418 on top of a gate dielectric layer 420. Two P-type diffusion regions 422 are formed adjacent to the gate dielectric layer 420 on the N well 414, serving as the source and drain. A N-type diffusion region 424 is formed by the isolation structure 416 on the N well 414, serving as a substrate contact. The drain of the PMOS transistor 408 is connected to ground, and its source is connected to the diffusion region 424 and further connected to the first pad 412. A part of the power guard ring 426 is depicted as a N-type diffusion region 426′ on the N well 414. The guard ring 426 surrounds a lager area, in which the PMOS transistor 408 is disposed as one of the devices. Typically, the guard ring 426 is constituted of a silicide layer, which is aligned with one or more metal layers and in contact with the same through interconnections. A part of the metal layers is removed to expose a segment of the silicide layer of guard ring 426, to form the voltage differentiation module 406 that is further connected to the gate conductor 418. When an ESD current flows through the voltage differentiation module 406, it generates a bias between the gate conductor 418 and the N well 414. This bias helps to turn on the PMOS transistor 408, and creates a surface current path under the gate dielectric layer 420, in addition to the substrate current path that is created by the avalanche breakdown across the source/drain diffusion regions 422.

Since the length of the exposed silicide composite determines the resistance value of the voltage differentiation module 406, the bias between the gate conductor 418 and N well 414 is adjustable by controlling the length of the silicide composite. Because the voltage differentiation module 406 comes from the guard ring, it occupies no additional layout area, and no complicated design is required to achieve this ESD protection circuit 404 with improved performance.

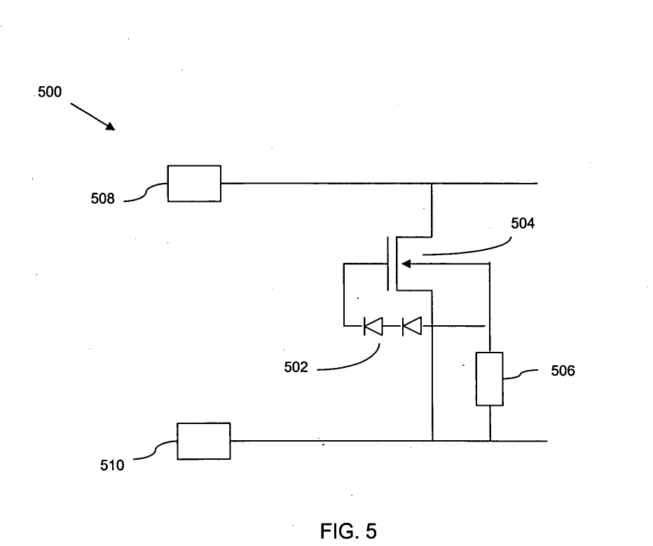

FIG. 5 illustrates an ESD protection circuit 500, in accordance with another embodiment of the present invention. The ESD protection circuit 500 is similar to the ESD protection circuit 302, as shown in FIG. 3A, except for a series of diodes 502 connected between the gate of the NMOS transistor 504 and a resistor 506, which is made from an exposed segment of a guard ring. The diodes 502 and the resistor 506 are collectively referred to as a voltage differentiation module. The NMOS transistor 504 is coupled to an input/output signals through the first pad 508, and to ground through the second pad 510.

In a normal operation, the NMOS transistor 504 is always turned off because its gate is connected to ground through the diodes 502 and the resistor 506. The voltage signals input through the first pad 508 will travel directly to a core circuit, without being diverted to the grounded second pad 510 through the NMOS transistor 504. In other words, the NMOS transistor 504 is invisible to the core circuit in the normal operation.

During an ESD event, a great amount of ESD current will be diverted to the guard ring, which is in connection with the second pad 510. Due to the resistance provided by the voltage differentiation module, which is composed of the diodes 502 and the resistor 506, a part of the current passing through it will generate a bias applied to the gate of the NMOS transistor 504. This helps to turn on the NMOS transistor 504, and creates a surface current path under its gate for passing the ESD current. As a result, the trigger voltage of the NMOS transistor 504 is lowered. This allows the NMOS transistor 504 to respond to the ESD current more quickly. Thus, the performance of the ESD protection circuit 500, as a whole, is improved.

It is noted that, according to another embodiment of the present invention, a PMOS transistor can be used, with a set of serially connected diodes and a resistor, to serve as an ESD protection circuit. A segment of a guard ring can be used to serve as the resistor. While no figure shows such embodiment, a person skilled in the art would be able to implement it, based on the description set forth above, without difficulties.

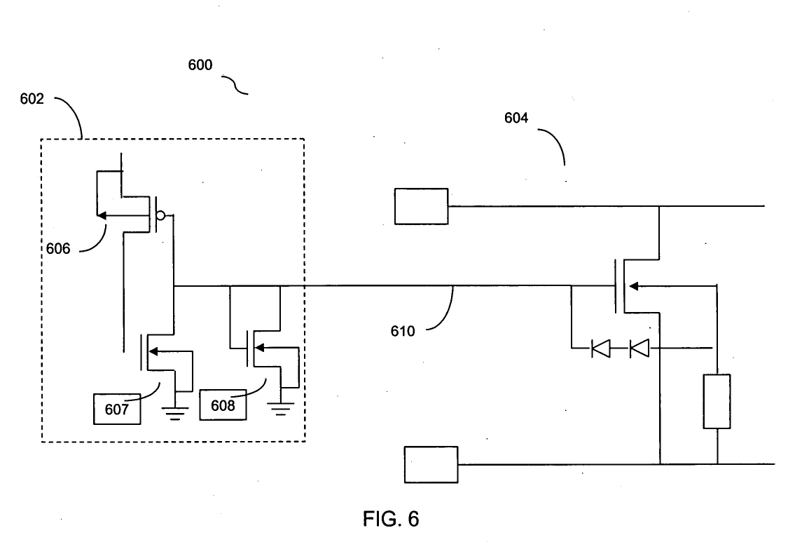

FIG. 6 illustrates an ESD protection circuit 600 with a tie low (TieL) circuit 602, in accordance with another embodiment of the present invention. The ESD protection circuit 600 is essentially a combination of the NMOS ESD protection circuit 604 and the TieL circuit 602, which is used to ensure that the NMOS ESD protection circuit 604 remains in an “off” condition, in a normal operation. The NMOS ESD protection circuit 604 is essentially the same as the ESD protection circuit 500, as shown in FIG. 5. The TieL circuit 602 operates at the supply voltage VDD. During the normal operation, a PMOS transistor 606 is used as a pull-up device to provide VDD to the gate of a NMOS transistor 608. This causes the NMOS transistor 608 to turn “on,” thereby tying a line 610 to ground. The line 610 in turn ensures that the NMOS ESD protection circuit 604 does not activate during the normal IC operation.

It is noted that, according to another embodiment of the present invention, a PMOS transistor can be used, with a set of serially connected diodes and a resistor, to serve as an ESD protection circuit. A segment of a guard ring can be used to serve as the resistor. A tie high circuit can be used to ensure that the PMOS transistor remains “off” in the normal operation. While no figure shows such embodiment, a person skilled in the art would be able to implement it, based on the description set forth above, without difficulties.

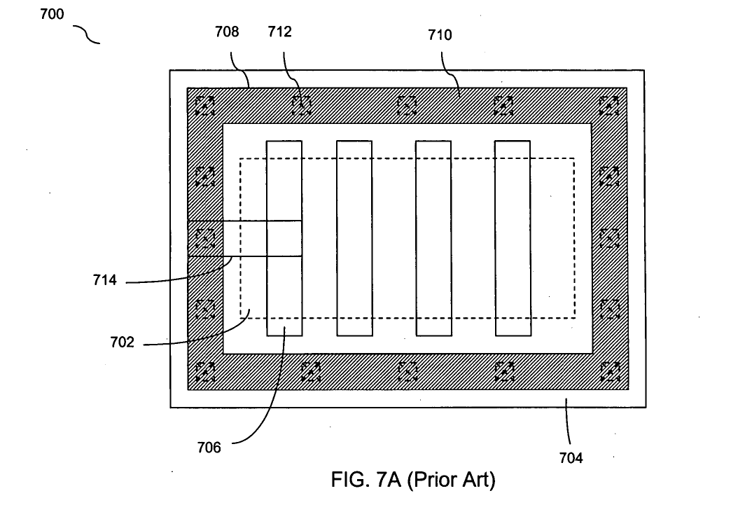

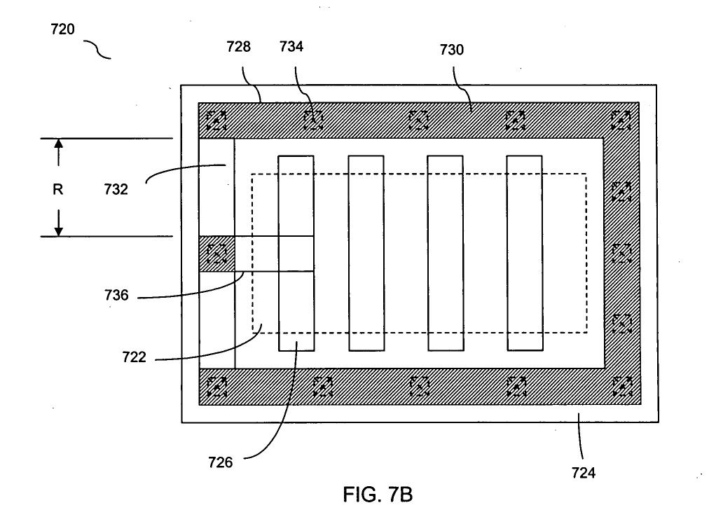

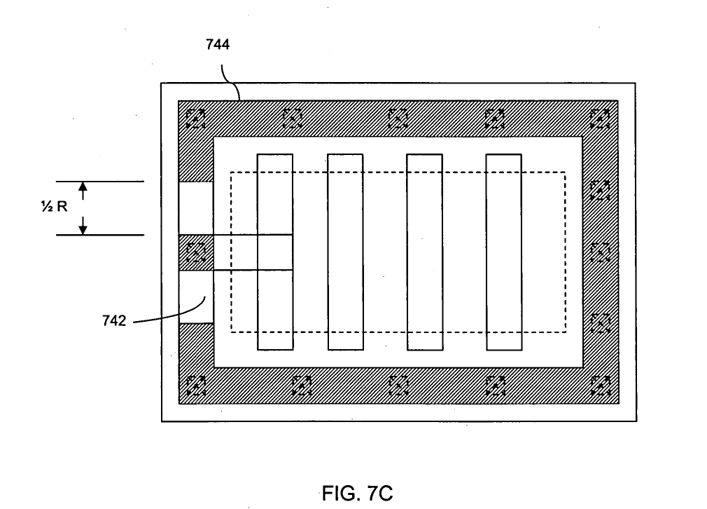

FIG. 7A shows a layout 700 of the conventional ESD protection circuit 102, as shown in FIG. 1A. A plurality of vertically extended gate structures 706 are formed atop a P-type substrate 704. Horizontally extended N+ doped regions 702 are formed adjacent to the gate structures 706 on the P-type substrate 704, serving as the sources and drains. The guard ring 708 surrounds the NMOS transistors formed by the N+ doped regions 702 and gate structures 706. The guard ring 708 is composed of a silicide layer (not shown in FIG. 7A), which is connected to a overlying metal layer 710 through inter-level contacts 712. The guard ring 708 is further connected to the gate structure 706 through conductive lines 714.

In a normal operation, the guard ring 708 is grounded, so that the gate structure 706 is connected to ground as well. This ensures that the NMOS transistors composed of the gate structure 706 and the N+ doped regions are turned off, and the ESD protection circuit 700 would have no effect on a core circuit under its protection. During an ESD event, since the gate structure 706 is coupled to ground through the guard ring 708, the surface current path would not be created under the gate structure 706. Thus, the trigger voltage of the ESD protection circuit 700 is relatively higher, as opposed to the ESD protection circuit that is able to create a surface current path during an ESD event, as disclosed above.

FIG. 7B shows a layout 720 of the ESD protection circuit 302, as shown in FIG. 3A, according to one embodiment of the present invention. A plurality of extended gate structures 726 are formed at a P-type substrate 724. A plurality of extended N+ doped regions 722 are formed adjacent to the gate structures 726 on the P-type substrate 724, serving as the sources and drains. The guard ring 728 surrounds the NMOS transistors formed by the N+ doped regions 722 and gate structures 726. The guard ring 728 is composed of a silicide layer 732, which is connected to an overlying metal layer 730 through inter-level contacts 734. The guard ring 728 is further connected to the gate structure 726 through conductive lines 736.

In this embodiment, a portion of the metal layer 730 is removed to expose the underlying silicide layer 732. This exposed silicide layer 732 creates a resistance, when a current flows therethrough. This, in turn, creates a bias on the gate conductor 726 during an ESD event.

In a normal operation, the guard ring 728 is grounded, so that the gate structure 726 is connected to ground as well. This ensures that the NMOS transistors composed of the gate structure 726 and the N+ doped regions 722 are turned off, and the ESD protection circuit 720 would have no effect on a core circuit under its protection. During an ESD event, the ESD current is diverted to the guard ring 728, and generates a surge of current. When the current flows through the exposed silicide layer 732, its resistance generates a bias that is applied to the gate structure 726 through the conductive lines 736. This helps to turn on the NMOS transistor, and creates a surface current path under the gate structure 726. Thus, the ESD current is dissipated to ground through the surface current path, in addition to a substrate current path that is created due to the avalanche break down of the NMOS transistor. This lowers the trigger voltage of ESD protection circuit 720, and, therefore, allows it to respond to an ESD event more quickly than the conventional design.

As comparing to the conventional layout as shown in FIG. 7A, the proposed layout 720 of the present invention does not occupy any extra area. It is fairly easy to create a bias on the gate of the NMOS transistor by using a segment of the exposed guard ring 728. Moreover, the magnitude of the bias can be modified by adjusting the length of the exposed segment of the guard ring 728. As shown in FIG. 7C, the exposed silicide layer 742 of the guard ring 744 is one half shorter than the exposed silicide layer 732 in FIG. 7B. Thus, the resistance value of the exposed silicide layer 742 is one half smaller than the exposed silicide layer 732. Accordingly, the bias created by the exposed silicide layer 742 is one half of that created by the exposed silicide layer 732.

It understood by those skilled in the art that while the layouts in FIGS. 7B and 7C are directed to a NMOS transistor based ESD protection circuit, the same concept can be used to design the layouts of a PMOS transistor based ESD protection circuit without difficulties.

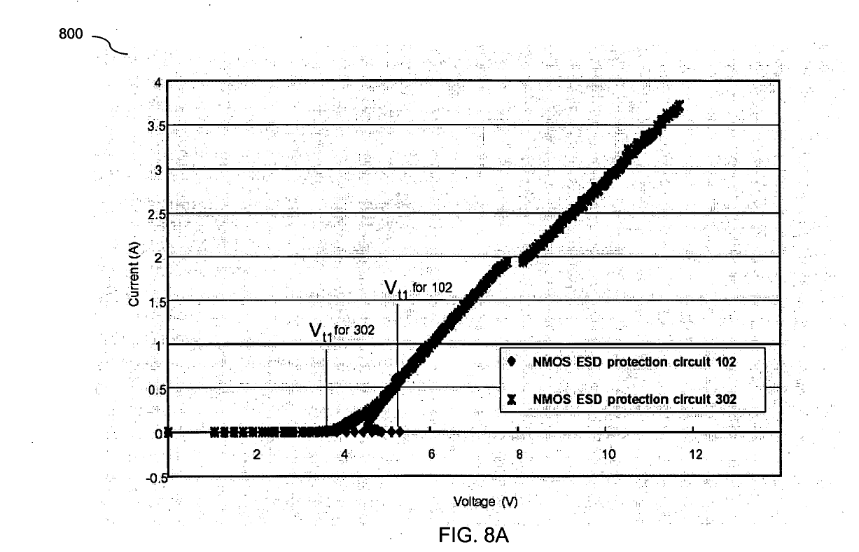

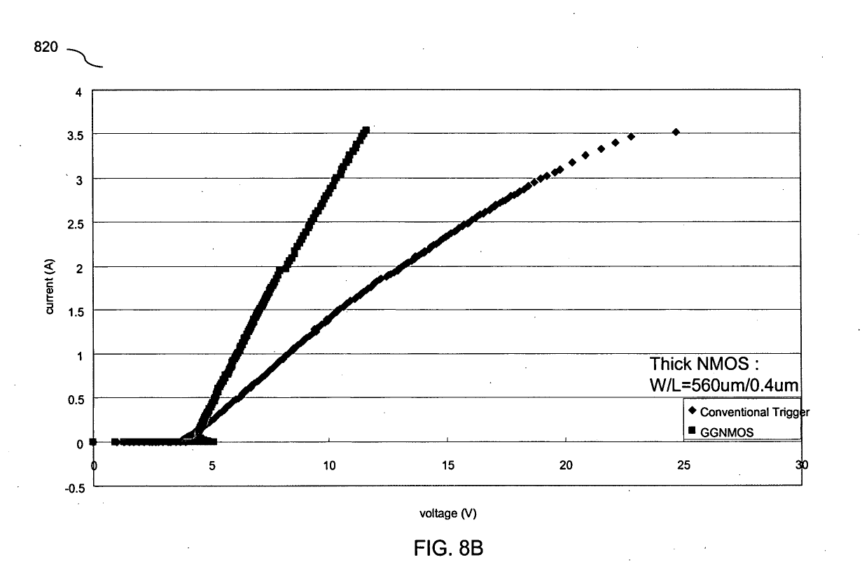

FIG. 8A presents a graph 800 comparing the threshold voltage of the conventional GGNMOS ESD protection circuit 102 (see FIG. 1A) and the ESD protection circuit 302 (see FIG. 3A), in accordance with the embodiment of the present invention. As shown in the graph 800, the trigger voltage of the conventional ESD protection circuit 102 is approximately 5.3V. The trigger voltage for the proposed ESD protection circuit 302 is approximately 3.75V. The current diverted through the conventional ESD protection circuit 102 and the proposed ESD protection circuit 302 are about the same. The lower trigger voltage allows the proposed ESD protection circuit 302 to respond to an ESD event more quickly.

FIG. 8B presents a graph 820 comparing the equivalent resistances of the proposed GGNMOS type ESD protection circuit 302 (see FIG. 3A) and conventional ESD protection circuits other than using GGNMOS transistors. As shown in graph 820, the resistance of a non-GGNMOS ESD protection circuit is much greater than that of a GGNMOS ESD protection circuit. Thus, the proposed GGNMOS type ESD protection circuit 302 can dissipate the ESD current more than other types of ESD protection circuits.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. An electrostatic discharge (ESD) protection circuit connected between a first pad and a second pad coupled to ground for diverting an ESD current during an ESD event, the ESD protection circuit comprising:
a NMOS transistor connected between the first pad and the second pad; and
a voltage differentiation module coupled between a gate of the NMOS transistor and the second pad for creating a bias on the gate during the ESD event, thereby activating a surface current path in addition to a substrate current path for dissipating the ESD current,
wherein the voltage differentiation module is formed by a segment of a guard ring that provides a predefined resistance determining the bias on the gate.

2. The ESD protection circuit of claim 1 wherein the segment has two ends in contact with a metal layer aligned with the guard ring.

3. The ESD protection circuit of claim 2 wherein the metal layer is discontinuous over the segment of the guard ring.

4. The ESD protection circuit of claim 3 wherein the segment of the guard ring uncovered by the metal layer comprises a silicide layer.

5. The ESD protection circuit of claim 1 wherein the resistance value of the voltage differentiation module is adjusted by varying a length of the segment of the guard ring.

6. The ESD protection circuit of claim 1 wherein a bulk of the NMOS transistor is connected to the second pad.

7. The ESD protection circuit of claim 1 further comprising at lease one diode coupled to the gate of the NMOS transistor, in series with the voltage differentiation module, for adjusting the bias on the gate.

8. The ESD protection circuit of claim 7 further comprising a tie low circuit coupled to the gate of the NMOS transistor for keeping the same in an off state in a normal operational mode.

9. An electrostatic discharge (ESD) protection circuit connected between a first pad and a second pad coupled to ground, comprising:
a PMOS transistor connected between the first pad and the second pad for diverting an ESD current from the first pad to the second pad during an ESD event; and
a voltage differentiation module connected between a gate of the PMOS transistor and the first pad for creating a bias on the gate during the ESD event, thereby activating a surface current path in addition to a substrate current path for dissipating the ESD current,
wherein the voltage differentiation module is formed by a segment of a guard ring that provides a predefined resistance determining the bias on the gate.

10. The ESD protection circuit of claim 9 wherein the segment has two ends in contact with a metal layer aligned with the guard ring.

11. The ESD protection circuit of claim 10 wherein the metal layer is discontinuous over the segment of the guard ring.

12. The ESD protection circuit of claim 11 wherein the segment of the guard ring uncovered by the metal layer comprises a silicide layer.

13. The ESD protection circuit of claim 9 wherein the resistance value of the voltage differentiation module is adjusted by varying a length of the segment of the guard ring.

14. The ESD protection circuit of claim 9 wherein a bulk of the PMOS transistor is connected to the first pad.

15. The ESD protection circuit of claim 9 further comprising at lease one diode coupled to the gate of the PMOS transistor, in series with the voltage differentiation module, for adjusting the bias on the gate.

16. A semiconductor layout of MOS transistor used in an electrostatic discharge (ESD) protection circuit for bypassing an ESD current thereacross during an ESD event, the semiconductor layout comprising:
at least one gate structure disposed on top of a semiconductor substrate;
at least one doped region underlying the gate structure in the semiconductor substrate, providing at least a source and a drain adjacent to the gate structure; and
a guard ring surrounding the gate conductor and the doped region,
wherein a segment of the guard ring is uncovered by a metal layer, which aligns with the guard ring and is in contact with two ends of the segment,
wherein one of the two ends of the segment is connected to the gate structure for providing a bias on the gate structure during the ESD event, thereby activating a surface current path under the gate structure between the source and drain, in addition to a substrate current path.

17. The semiconductor layout of claim 16 wherein the bias is adjusted by varying a length of the segment of the guard ring.

18. The semiconductor layout of claim 16 wherein the doped region is doped with N-type impurities, such that, together with the gate structure, constituting a NMOS transistor.

19. The semiconductor layout of claim 18 wherein the segment of the guard ring is coupled to ground.

20. The semiconductor layout of claim 16 wherein the doped region is doped with P-type impurities, such that, together with the gate structure, constituting a PMOS transistor.

21. The semiconductor layout of claim 20 wherein the segment of the guard ring is coupled to an input/output pad.
